(19) United States
(12) Patent Application Publication
(10) Pub. No.: US 2001/0045151 A1
(43) Pub. Date: Nov. 29, 2001

(54) Music staff sheet-printing device for practicing musical instruments

(76) Inventor: Toshio Hayakawa, Los Angeles, CA (US)

Correspondence Address: Toshio Hayakawa, 10021 Tabor Street # 311, Los Angeles, CA, 90034, US

(21) Appl. No.: 09/866,220

(22) Filed: May 25, 2001

Related U.S. Application Data
(60) Provisional application No. 60/205,086, filed on May 18, 2000.

(51) Int. Cl. G10G 3/04

(52) U.S. Cl. 84/462

(57) ABSTRACT

The purposes of this device (100) is to convert and print mechanical strokes of music instruments onto papers as five-line music sheets (60) by sensing motion of mechanical strokes played by a musical instrument player. A typical application for this newly invented device is to monitor key stokes of an acoustic piano (10) played by a musical instrument player. Conventionally, a music teacher listens while the musical instrument player plays the piano. To check skill of novice and beginner players require to have well-trained music teachers. Using this newly invented printing device for musical instruments can check their skills by printing music notes played by them since this device (100) can store and print key stokes as the five-line music sheets (60). Once it prints as the five-line music sheets (60), the musical instrument players can check visually whether correct keys are pressed or not, by comparing the output printed out (60) by the device (100) and original music sheets.

### CROSS REFERENCE TO RELATED APPLICATIONS

This application claims the benefit of Provisional Patent Application Ser. No. 60/205,086 filed May 18, 2000.

### BACKGROUND

1. Field of Invention

This invention relates to a music device that increases performance of a musical instrument player.

2. Description of Prior Art

A musical instrument player often starts taking music lessons from the early age as young as two or three years old. Taking a piano lesson is no exception. Giving piano lesson to children are always fun and exciting events for both children and their parents. These lessons require always very diligent, patient, hard working, and enormous support from their parents and teachers. Hence, over many years there are many devices were invented to give support for them. One of the most noticeable musical instruments invented is an electronic keyboard. It certainly made the musical instrument players easier to learn how to play the piano inexpensive and fun way because it can create and edit piano sound as well as other musical instrument types. However, the electronic keyboard instrument is not quite same as an acoustic piano. For example, the acoustic piano has more octave range than electric keyboard physically. Another reason is that musics for piano are written in wider octave range than the physical key lay out on the electronic keyboard. Hence, the acoustic piano is more suitable than the electric keyboard. Therefore, the musical instrument players prefer to practice using the acoustic piano. Furthermore, giving piano lesson to children often cause financial burden for their parents. For these reasons, the five-line music sheet-printing device for musical instruments is invented. They can practice piano at their home since this newly invented device can monitor precisely how they press keys on a piano. Furthermore, the musical instrument players do not need to visit their music teachers as often as used to be thereby they can save their lesson fee and time for practice.

U.S. Pat. No. 4,352,313 to Ny (1982) discloses that a piano-type keyboard unit mounts on alphanumeric keys of keyboard of a computer so that a user can input music to store in memory. Later the user can print it on sheet music form. The device is mainly used to input music into memory of personal computer so that it can print on sheet music form. However, it is not suitable for practicing an acoustic piano or any other musical instruments since the unit mounts on the alphanumeric keys of keyboard of a computer.

U.S. Pat. No. 6,069,310 to James (2000) discloses a method of controlling remote piano equipment over the Internet and a method of subscribing musics to subscribers using remote an piano. This invention is not for practicing the acoustic piano. Rather, it is for playing the acoustic piano for subscription purpose. This method is very much different from my five-line music sheet-printing device because one of the purposes of the newly invented device is to print the five-line music sheets for practicing the acoustic piano so that a musical instrument player can find out whether they hit wrong keys or not.

U.S. Pat. No. 6,054,641 to Inoue (2000) discloses a keyboard musical instrument for practicing fingering on keyboard without acoustic sound. His invention replaces the sound created by hammer hits with tone generator such that a piano player will not disturb their neighbors while they practice. Again, the purpose of this invention is to simply replace piano sound with sound generator or headphone set which is different from the five-line music sheet-printing device.

U.S. Pat. No. 5,894,099 to Niitsuma (1999) discloses keyboard sensor apparatus for an acoustic piano. This invention is to provide simple and cost effective for manufacturing purpose while the pianos are assembled in their factories. The purpose of this invention is for the keyboard assembly with rubber switch sensors. These sensors are mounted underneath of each key thereby it is different from the sensors used for the five-line music sheet-printing device. The motion sensor of the newly invented device is installed on the top of piano key unlike the invention by Niitsuma is assembled underneath of piano keys by manufactures. On the contrary, a musical instrument player installs the motion sensor of the five-line music sheet-printing device. Furthermore, it is portable so that it can install on any acoustic pianos. Therefore, the sensor of the newly invented device is different from the keyboard sensor presented by Niitsuma.

### OBJECTIVE AND ADVANTAGE

Accordingly, besides the objects and advantages of the five-line music sheet-printing device described in this patent, several objects and advantages of the present invention are:

(a) to provide the device that can print five-line music sheets can be compared with original music sheets to see if there are errors made or not as musical instrument players practices musical instruments;

(b) to provide the device that can improve performance of the musical instrument players;

(c) to provide the device that the musical instrument players can save lesson fee and time using this device since repetitive lesson fees are not required; and

(d) to provide the device that the musical instrument player can make hardcopy duplicates of own music notes easily.

### SUMMARY

A conventional way to practice music instruments such as a piano is to simply play the piano and record the playing music by conventional recording devices such as tape players and playing the recorded music back. Then a musical instrument player can find out where mistakes occur while they listen to the tape player. Alternatively, a music teacher can listen while the musical instrument player plays. Finding and correcting any errors made by the musical instrument player depends on the capability of human ears. However, the human ears have limited hearing capability to be able to listen with high degree of accuracy. Hence, the music teachers or the musical instrument players can not catch all errors by checking the recorded sound or while the music teachers or the musical instrument players listen. This task requires highly trained a music teacher when a novice musical instrument player plays. Often correcting any errors made by them are far more difficult than finding errors made by beginners. By using this newly invented printing device, any musical instrument players can find out mistakes by comparing the printout paper printed by the device and original music sheets since the sensor detects the motion of the keys without error.

Once all music notes played is stored on this device, by pressing a print button located on the device will print the recorded music as the form of five-line music sheets with music notes. Then, the musical instrument players can check visually where they hit wrong keys during practices by comparing the printed document and the original music sheets since the device prints the recorded music in the regular five-line music notes format. Thereby the musical instrument players can improve performance skill in short time because they can see mistakes visually instead of listening to sound.

### BRIEF DESCRIPTION OF THE DRAWING FIGURES

FIG. 1 shows the newly invented device how it connects with a musical instrument using an acoustic piano as the example application.

FIG. 2 shows the functional block diagram of the newly invented printing device for musical instruments using the acoustic piano.

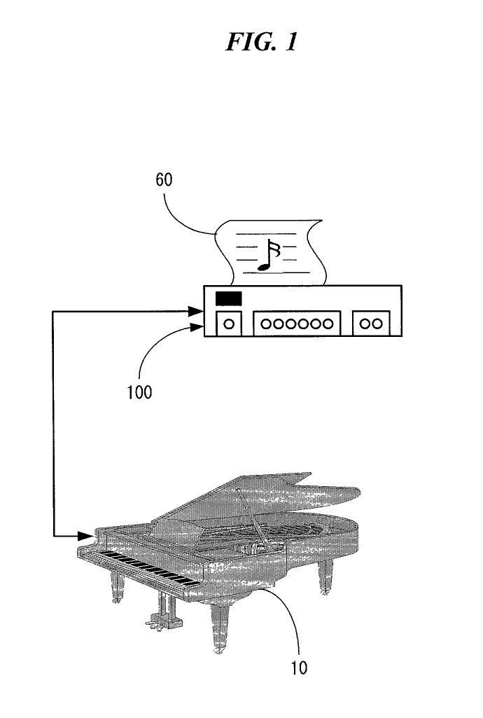

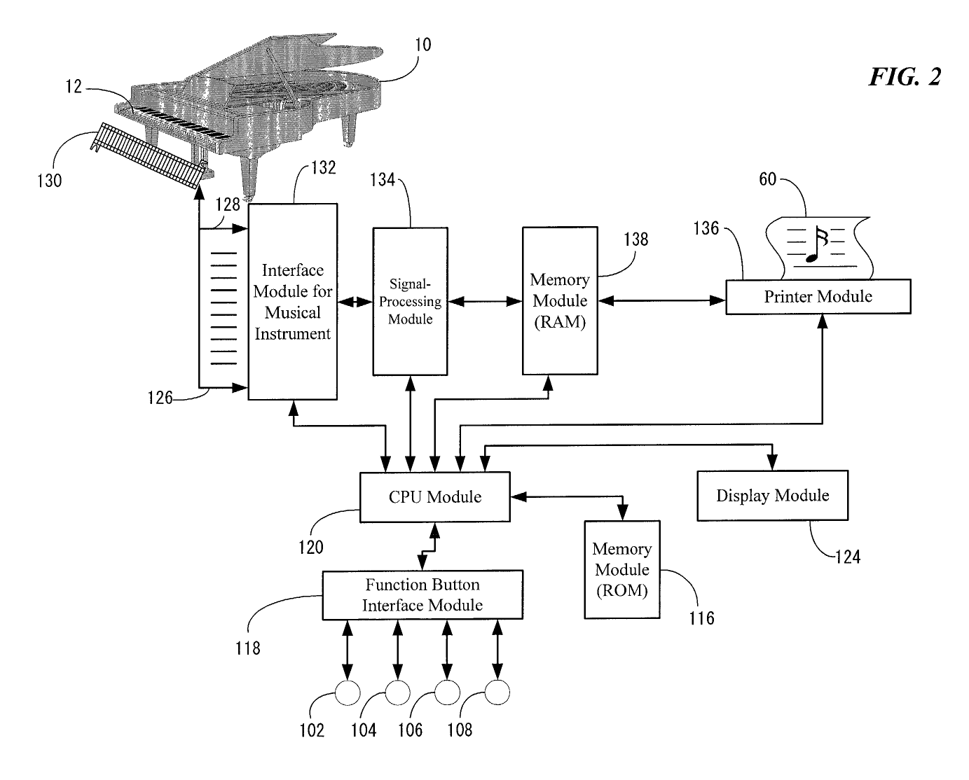

### DETAILED DESCRIPTION OF THE PREFERRED EMBODIMENT—FIGS. 1 AND 2

FIG. 1 illustrates a typical connection diagram of a newly invented device 100. The device 100 is connected to the acoustic piano 10 as the typical example application. In reality, the device 100 can connect with any musical instruments by changing the physical shapes of the motion sensor 130 (FIG. 2).

Referring to FIG. 2, the device 100 (FIG. 1) consists of several modules such as a function button interface module 118, a display module 124, an interface module for musical instrument 132, and a printer module 136. These modules work as I/O (input and output) modules between a musical instrument player and the newly invented device 100.

Referring to FIG. 2, a printer module 136 located inside the device 100 (FIG. 1) prints recorded music onto a paper 60 out of the device 100 as the form of five-line music sheets 60. A roll of paper is stored in the device 100 so that the device 100 can print recorded music in continues fashion.

Referring to FIG. 2, a signal-processing module 134 receives signals that are generated by the motion sensor 130. Once the signal-processing module 134 receives the signals through the interface module for musical instrument 132, the signal-processing module 134 arranges the signals for printing format. Then, the signal-processing module 134 sends data to the memory module 138 RAM (random access memory) for later printing.

Referring to FIG. 2, the device 100 has function buttons to control the functions of this newly invented device. These buttons are a print button 108, a record button 106, a start button 102, and a stop button 104.

Referring to FIG. 2, a display module 124 is located on the device 100. The purpose of the display module 124 is to display responses resulted by the functions of the device 100 when the musical instrument player pushes the buttons located on the device 100. It acts like a computer monitor on a computer so that they can see how this device 100 operates with respect to functionality of buttons of the device 100.

Referring to FIG. 2, a motion sensor 130 for the piano keys 12 connects to the device 100. The purpose of the motion sensor 130 is to measure how the musical instrument player hits the keys 12, and which ones are pressed. For each piano key 12 on the piano 10 has a single sensor to measure the motion of the keys 12. The motion sensor 130 comprises of photodiodes or any mechanical sensors. The type of sensors depends on who practices the acoustic piano. For beginners, any types of sensors are used to detect the motion of key 12. For novice players, the motion sensor 130 is comprised of electronics photodiodes so that feeling of keyboard touch is not affected by the motion sensor 130. Further, a musical instrument player places the motion sensor 130 on the top of the keys 12 rather than it is installed under the key 12 at piano manufacturing sites. The motion sensor 130 is also portable so that the musical instrument player can carry it to anywhere they go and use it on any pianos. In addition, the width of the motion sensor 130 will not protrude forward since they are constructed with small photodiodes as sensors. Therefore, it will not disturb the musical instrument player's fingers when it is placed on the top of keys 12.

Referring to FIG. 2, all of these I/O devices are controlled by a CPU module 120, a memory module 116 ROM (read only memory), a signal processing module 134, a memory module RAM (random access memory) 138, and a function button interface module 118.

From the description above, a number of advantages of my five-line music sheet-printing device for practicing musical instruments such as the acoustic piano become evident:

(a) No tape recorder is required to record playing music to find out how accurately the musical instrument player is practicing. All music notes played by them are printed as the five-line music sheets thereby finding errors can be checked visually very easily.

(b) Practicing with this newly invented device is the same as having a music teacher giving lessens to the musical instrument players at any time.

(c) It can improve performance of the musical instrument players;

(d) The musical instrument players can save lesson fee and time using this device since repetitive lesson fees are not required; and

(e) The musical instrument players can make duplicate copy of own music notes easily.

Operation—FIGS. 1 and 2

To record the motion of the piano keys 12 of the piano 10 using the newly invented device 100 (FIG. 1) is that a musical instrument player simply pushes a record button 106 and a start button 102 sequentially before he/she begins. Once the musical instrument player finishes playing the music, he/she pushes a stop button 104 at any time. At this moment, the music played is converted and stored in a memory module 138 as a digital format. When the musical instrument player pushes a print button 108, the device 100 prints five-line music sheets 60 with recorded music notes which it should be identical to original music sheets if there is no mistakes. However, if there are mistakes, the player can find out visually where he/she hit wrong keys easily by comparing the five-line music sheets 60 with the original music sheets.

Conclusion, Ramifications, and Scope

Accordingly, the reader will see that the five-line music sheet-printing device for practicing musical instruments can be used as a virtual music teacher. Having this device will save lesson fee that is normally paid to music teachers. For novice musical instrument player, they can compose their music easily by using this device on any musical instruments since all notes played by them is printed as the form of five-line music sheets. Furthermore, the device has the additional advantages in that

a musical instrument player's performance can be improved well using this device;

the musical instrument player can save lesson fee and time using this device since repetitive lesson fees are not required; and

the printed five-line music sheets can be duplicated since they are printed as the hard copy.

Although the description above contains many specifications, these should not be construed as limiting the scope of the invention but as merely providing illustrations of some of the presently preferred embodiments of this invention. For example, the device can connect to other musical instrument types by modifying the sensor.

Thus, the scope of the invention should not be determined by the appended claims and their legal equivalent, rather than by the example given.

I claim:

1. A printing device for a music instrument comprising:
(a) a motion sensor means sensing a plurality of key strokes pressed by a plurality of musical instrument players;
(b) a printer module means getting recorded music notes data from a memory module RAM and printing the recorded music notes data onto a plurality of papers,
wherein the recorded music notes is stored in said memory module RAM; and
(c) a plurality of function buttons means operating said printing device for the musical instruments.

2. The printing device for the musical instrument of claim 1, wherein the motion sensor connects to a interface module for musical instrument, a signal processing module, and a CPU module,

3. The printing device for the musical instrument of claim 1, wherein the printing module connects to said memory module RAM and said CPU module.

4. The printing device for the musical instrument of claim 1, wherein a plurality of function buttons connects a function button interface module,
wherein the plurality of function buttons includes;
a print button for activating said CPU module and said printing module for printing the recorded music notes data;
a record button for setting scanning key motions of the musical instruments means that said interface module for musical instrument starts to scan the plurality of keys;
a start button means activating said CPU module for storing the key motion to said memory module RAM or printing the recorded music notes data from said memory module RAM onto a plurality of papers; and
a stop button means activating said CPU module for terminating scanning key motions of the musical instrument.
